(19) United States
(12) Patent Application Publication
(10) Pub. No.: US 2016/0105927 A1
(43) Pub. Date: Apr. 14, 2016

(54) METHOD FOR PERFORMING A DRX OPERATION IN A WIRELESS COMMUNICATION SYSTEM AND A DEVICE THEREFOR

(71) Applicant: LG ELECTRONICS INC., Seoul (KR)

(72) Inventors: Sunyoung LEE, Seoul (KR); Sungjun PARK, Seoul (KR); Seungjune YI, Seoul (KR)

(73) Assignee: LG ELECTRONICS INC., Seoul (KR)

(21) Appl. No.: 14/889,788

(22) PCT Filed: May 14, 2014
(86) PCT No.: PCT/KR2014/004313

§ 371 Date: Nov. 6, 2015

Related U.S. Application Data
(60) Provisional application No. 61/823,412, filed on May 15, 2013.

(51) Int. Cl. H04W 76/04; H04W 36/30

(52) U.S. Cl. CPC H04W 76/048; H04W 36/30; H04W 76/046

(57) ABSTRACT

The present invention relates to a wireless communication system. More specifically, the present invention relates to a method and a device for preforming a DRX (Discontinuous Reception) operation in a wireless communication system, the method comprising: receiving information on criterion for transition to an Active Time; measuring radio quality of a cell; and transiting to the Active Time when the radio quality meets the criterion.

### TECHNICAL FIELD

The present invention relates to a wireless communication system and, more particularly, to a method for performing a DRX (Discontinuous Reception) operation and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### DISCLOSURE

### Technical Problem

An object of the present invention devised to solve the problem lies in a method and device for performing a DRX operation in a wireless communication system. The technical problems solved by the present invention are not limited to the above technical problems and those skilled in the art may understand other technical problems from the following description.

### Technical Solution

The object of the present invention can be achieved by providing a method for operating by an user equipment (UE) in wireless communication system, the method comprising; receiving information on criterion for transition to an Active Time; measuring radio quality of a cell; and transiting to the Active Time when the radio quality meets the criterion.

In another aspect of the present invention, provided herein is a UE (User Equipment) in the wireless communication system, the UE comprising: an RF (radio frequency) module; and a processor configured to control the RF module, wherein the processor is configured to receive information on criterion for transition to an Active Time, measure radio quality of a cell; and transit to the Active Time when the radio quality meets the criterion.

Preferably, the method further comprising: receiving an RRC (Radio Resource Control) signaling is received from a base station (BS) in a serving cell during the Active Time.

Preferably, the method further comprising: transiting to an Inactive Time when the RRC signaling is received from the BS during the Active Time.

Preferably, the RRC signaling is a handover command signaling.

Preferably, the method further comprising: indicating a result of said transiting to the Active Time, to a base station in a serving cell.

Preferably, the method further comprising: transmitting a result of said measuring the radio quality of the cell, to a base station in a serving cell.

It is to be understood that both the foregoing general description and the following detailed description of the present invention are exemplary and explanatory and are intended to provide further explanation of the invention as claimed.

### Advantageous Effects

According to the present invention, a DRX operation can be efficiently performed in a wireless communication system. Specifically, when the UE receives criterion information and measures radio quality of a cell, the UE can transit to an Active Time in order to receive a RRC signaling if the radio quality meets the criterion information.

It will be appreciated by persons skilled in the art that that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4 is a diagram of an example physical channel structure used in an E-UMTS system;

FIG. 5 is a diagram showing the structure of a radio frame used in a Long Term Evolution (LTE) system;

FIG. 6 is a diagram showing a concept of DRX (Discontinuous Reception);

FIG. 7 is a diagram showing a method for a DRX operation in the LTE system;

FIG. 8 is a conceptual diagram for performing measurement and reporting the measurement result by a UE.

FIG. 9 is a diagram showing a method for a Long-DRX operation in the LTE system;

FIG. 10 is a conceptual diagram for performing a DRX operation according to embodiments of the present invention;

FIG. 11 is conceptual diagram an exemplary DRX operation according to embodiments of the present invention; and

FIG. 12 is a block diagram of a communication apparatus according to an embodiment of the present invention.

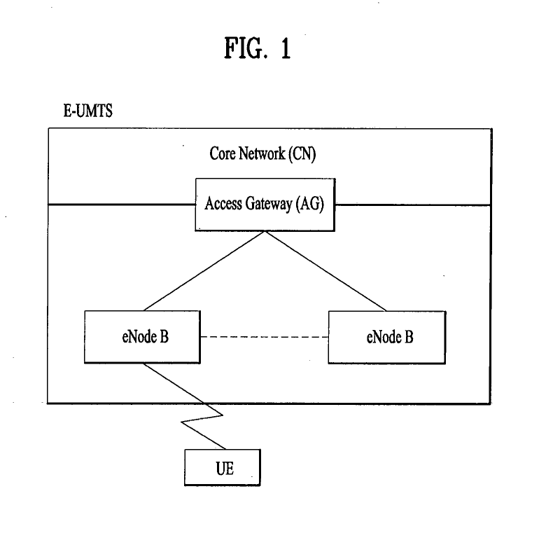

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

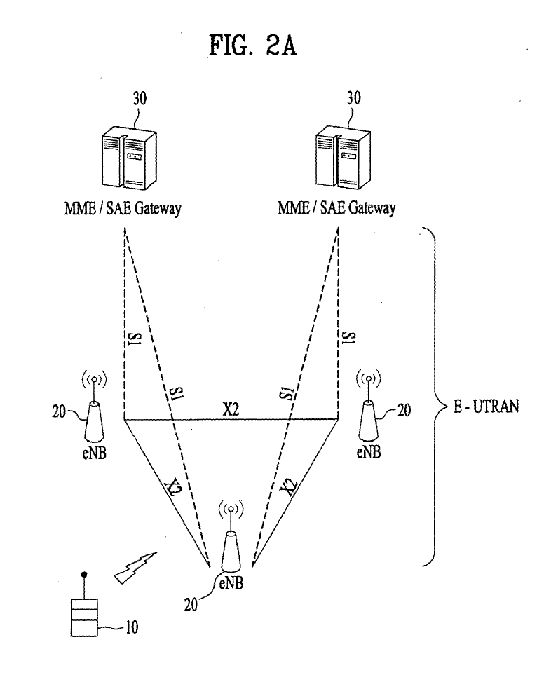

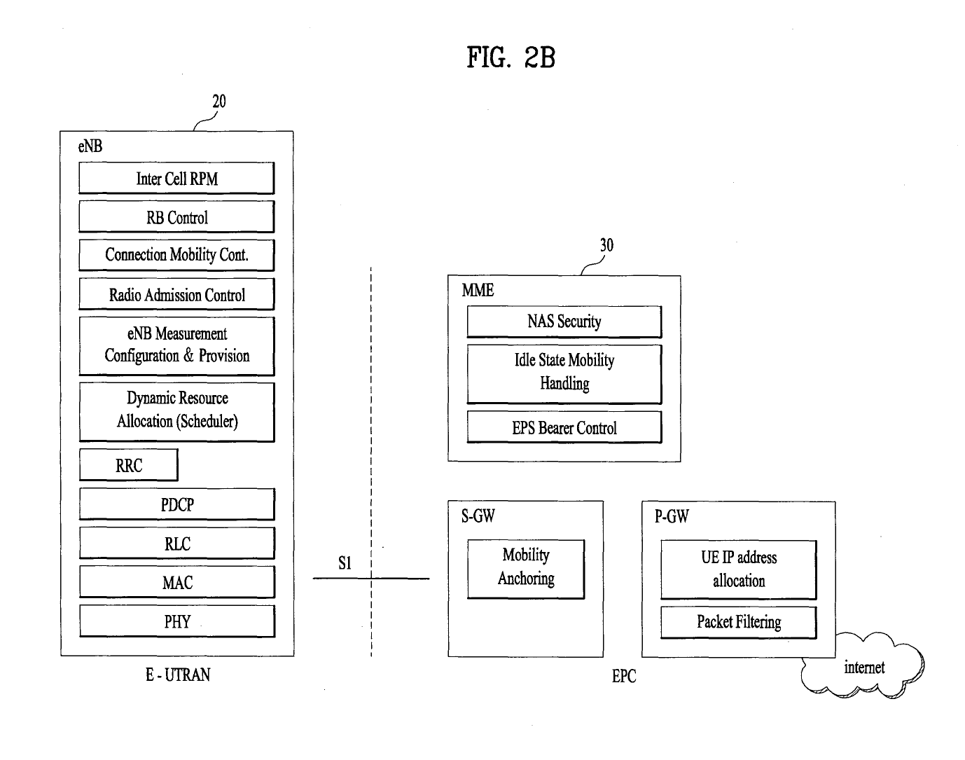

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC. As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

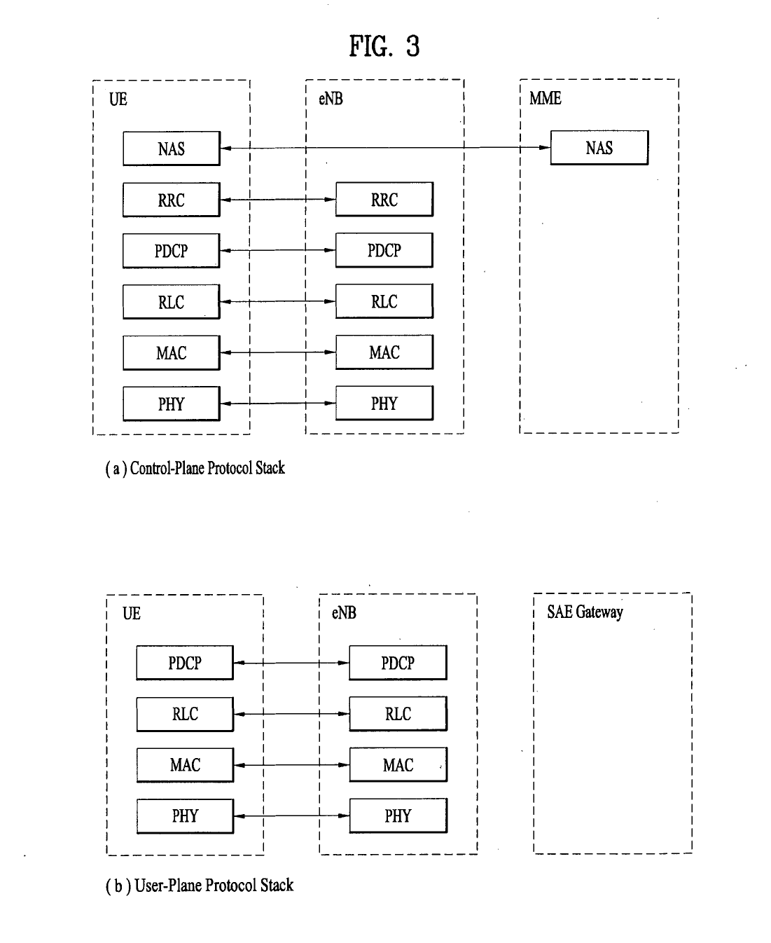

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

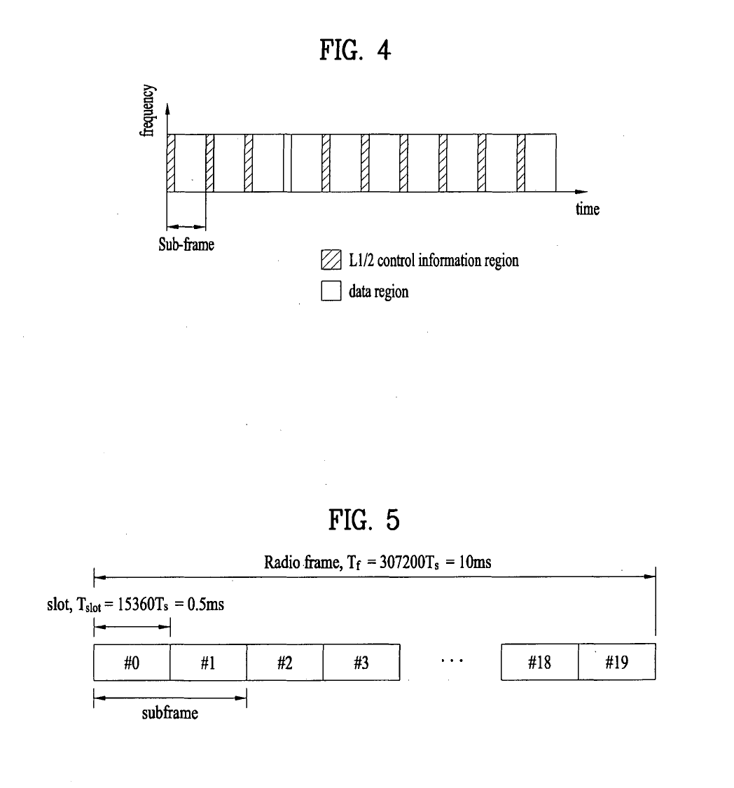

FIG. 4 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 4, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A transmission time interval (TTI) which is a unit time for transmitting data is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

FIG. 5 is a diagram showing the structure of a radio frame used in an LTE system.

Referring to FIG. 5, the radio frame has a length of 10 ms (327200×Ts) and is divided into 10 subframes having the same size. Each of the subframes has a length of 1 ms and includes two slots. Each of the slots has a length of 0.5 ms (15360×Ts). Ts denotes a sampling time, and is represented by Ts=1/(15 kHz×2048)=3.2552×10-8 (about 33 ns). Each of the slots includes a plurality of OFDM symbols in a time domain and a plurality of Resource Blocks (RBs) in a frequency domain. In the LTE system, one RB includes 12 subcarriers×7 (or 6) OFDM symbols. A transmission time interval (TTI) that is a unit time for transmission of data may be determined in units of one or more subframes. The structure of the radio frame is purely exemplary and thus the number of subframes included in the radio frame, the number of slots included in a subframe, or the number of OFDM symbols included in a slot may be changed in various ways.

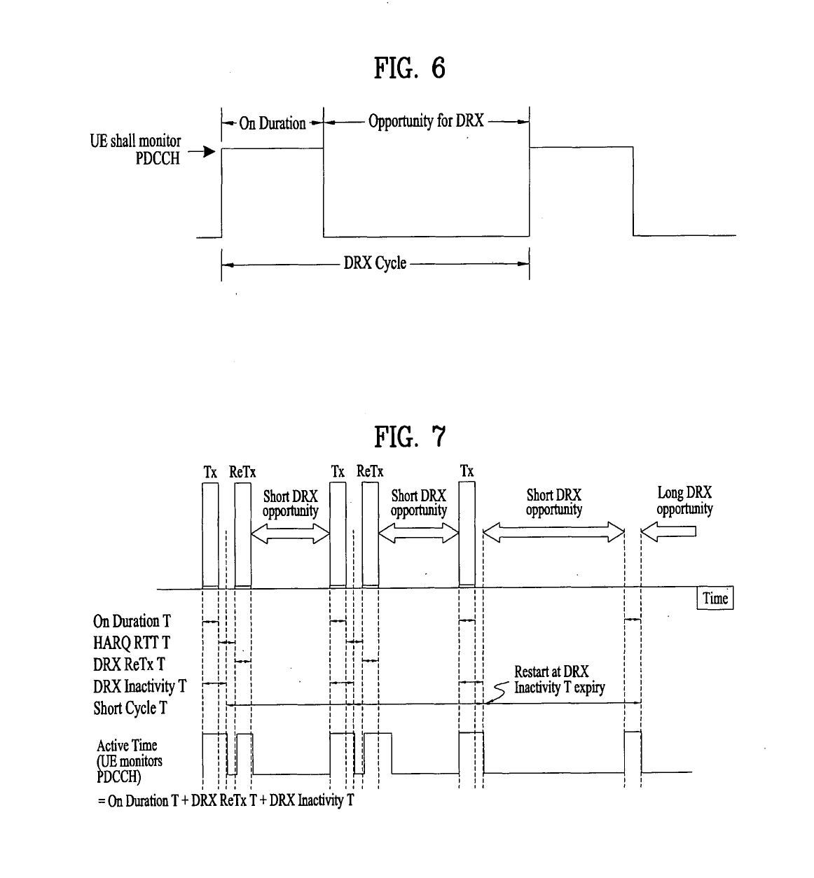

FIG. 6 is a diagram showing a concept DRX (Discontinuous Reception).

Referring to FIG. 6, if DRX is set for a UE in RRC_CONNECTED state, the UE attempts to receive a downlink channel, PDCCH, that is, performs PDCCH monitoring only during a predetermined time period, while the UE does not perform PDCCH monitoring during the remaining time period. A time period during which the UE should monitor a PDCCH is referred to as “On Duration”. One On Duration is defined per DRX cycle. That is, a DRX cycle is a repetition period of On Duration.

The UE always monitors a PDCCH during On Duration in one DRX cycle and a DRX cycle determines a period in which On Duration is set. DRX cycles are classified into a long DRX cycle and a short DRX cycle according to the periods of the DRX cycles. The long DRX cycle may minimize the battery consumption of a UE, whereas the short DRX cycle may minimize a data transmission delay.

When the UE receives a PDCCH during On Duration in a DRX cycle, an additional transmission or a retransmission may take place during a time period other than the On Duration. Therefore, the UE should monitor a PDCCH during a time period other than the On Duration. That is, the UE should perform PDCCH monitoring during a time period over which an inactivity managing timer, drx-InactivityTimer or a retransmission managing timer, drx-RetransmissionTimer as well as an On Duration managing timer, onDurationTimer is running.

The value of each of the timers is defined as the number of subframes. The number of subframes is counted until the value of a timer is reached. If the value of the timer is satisfied, the timer expires. The current LTE standard defines drx-InactivityTimer as a number of consecutive PDCCH-subframes after successfully decoding a PDCCH indicating an initial UL or DL user data transmission and defines drx-RetransmissionTimer as a maximum number of consecutive PDCCH-subframes for as soon as a DL retransmission is expected by the UE.

Additionally, the UE should perform PDCCH monitoring during random access or when the UE transmits a scheduling request and attempts to receive a UL grant.

A time period during which a UE should perform PDCCH monitoring is referred to as an Active Time. The Active Time includes On Duration during which a PDCCH is monitored periodically and a time interval during which a PDCCH is monitored upon generation of an event.

More specifically, the Active Time includes the time while (1) onDurationTimer or drx-InactivityTimer or drx-RetransmissionTimer or mac-ContentionResolutionTimer is running, or (2) a Scheduling Request is sent on PUCCH and is pending, or (3) an uplink grant for a pending HARQ retransmission can occur and there is data in the corresponding HARQ buffer, or (4) a PDCCH indicating a new transmission addressed to the C-RNTI of the UE has not been received after successful reception of a Random Access Response for the preamble not selected by the UE.

FIG. 7 is a diagram showing a method for a DRX operation in the LTE system.

Referring to FIG. 7, the UE may be configured by RRC with a DRX functionality and shall perform following operations for each TTI (that is, each subframe).

If a HARQ RTT (Round Trip Time) Timer expires in this subframe and the data of the corresponding HARQ process was not successfully decoded, the UE shall start the drx-RetransmissionTimer for the corresponding HARQ process.

Further, if a DRX Command MAC control element (CE) is received, the UE shall stop onDurationTimer and drx-InactivityTimer. The DRX Command MAC CE is a command for shifting to a DRX state, and is identified by a LCID (Logical Channel ID) field of a MAC PDU (Protocol Data Unit) subheader.

Further, in case that drx-InactivityTimer expires or a DRX Command MAC CE is received in this subframe, if the Short DRX cycle is configured, the UE shall start or restart drxShortCycleTimer, and use the Short DRX Cycle. However, if the Short DRX cycle is not configured, the Long DRX cycle is used. Additionally, if drxShortCycleTimer expires in this subframe, the Long DRX Cycle is also used.

The UE shall monitor the PDCCH for a PDCCH-subframe during the Active Time. If the PDCCH indicates a DL transmission or if a DL assignment has been configured for this subframe, the UE shall start the HARQ RTT Timer for the corresponding HARQ process and stop the drx-RetransmissionTimer for the corresponding HARQ process. If the PDCCH indicates a (DL or UL) new transmission, the UE shall start or restart drx-InactivityTimer.

Here, the PDCCH-subframe is defined as a subframe with PDCCH. That is, the PDCCH-subframe is a subframe on which the PDCCH can be transmitted. More specifically, in a FDD (frequency division duplex) system, the PDCCH-subframe represents any subframe. For full-duplex TDD (time division duplex) system, the PDCCH-subframe represents the union of downlink subframes and subframes including DwPTS of all serving cells, except serving cells that are configured with schedulingCellId (that is, the Scheduled cell). Here, the schedulingCellId indicates an identity of the scheduling cell. Further, for half-duplex TDD system, the PDCCH-subframe represents the subframes where the PCell (primary cell) is configured as a downlink subframe or a subframe including DwPTS.

Meanwhile, when not in Active Time, the UE does not perform a SRS (Sounding Reference Signal) transmission and a CSI reporting, which are triggered by the eNB.

During the above DRX operation, only the HARQ RTT Timer is fixed to 8 ms, whereas the eNB indicates the other timer values, onDurationTimer, drx-InactivityTimer, drx-RetransmissionTimer, and mac-ContentionResolutionTimer to the UE by an RRC signal. The eNB also indicates a long DRX cycle and a short DRX cycle, which represent the period of a DRX cycle, to the UE by an RRC signal.

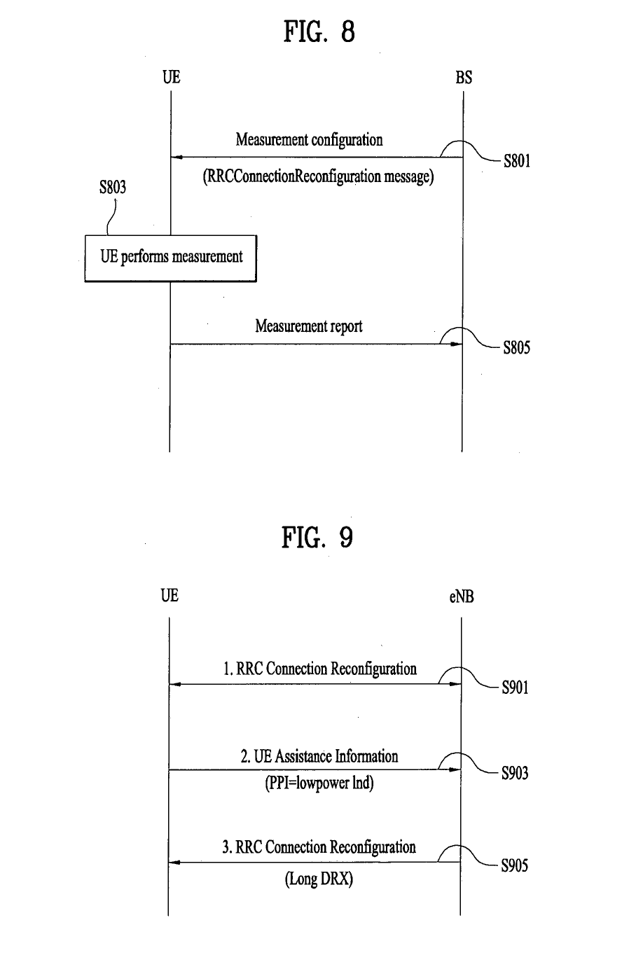

FIG. 8 is a conceptual diagram for performing measurement and reporting the measurement result by a UE.

E-UTRAN (Evolved-UMTS Terrestrial Radio Access Network) provides the measurement configuration applicable for a UE in RRC_CONNECTED by means of dedicated signaling, i.e. using the RRCConnectionReconfiguration message (S801).

The UE can be requested to perform the following types of measurements (S803): i) measurements at the downlink carrier frequency(ies) of the serving cell(s) (Intra-frequency measurements), ii) measurements at frequencies that differ from any of the downlink carrier frequency(ies) of the serving cell(s) (Inter-frequency measurements), iii) Inter-RAT measurements of UTRA frequencies, iv) Inter-RAT measurements of GERAN frequencies, v) Inter-RAT measurements of CDMA2000 HRPD or CDMA2000 1×RTT frequencies.

The measurement configuration includes the following parameters:

1. Measurement objects: The objects on which the UE shall perform the measurements. i) For intra-frequency and inter-frequency measurements a measurement object is a single E-UTRA carrier frequency. Associated with this carrier frequency, E-UTRAN can configure a list of cell specific offsets and a list of ‘blacklisted’ cells. Blacklisted cells are not considered in event evaluation or measurement reporting, ii) For inter-RAT UTRA measurements a measurement object is a set of cells on a single UTRA carrier frequency, iii) For inter-RAT GERAN measurements a measurement object is a set of GERAN carrier frequencies, iv) For inter-RAT CDMA2000 measurements a measurement object is a set of cells on a single (HRPD or 1×RTT) carrier frequency.

2. Reporting configurations: A list of reporting configurations where each reporting configuration consists of the following: i) Reporting criterion: The criterion that triggers the UE to send a measurement report. This can either be periodical or a single event description, ii) Reporting format: The quantities that the UE includes in the measurement report and associated information (e.g. number of cells to report).

3. Measurement identities: A list of measurement identities where each measurement identity links one measurement object with one reporting configuration. By configuring multiple measurement identities it is possible to link more than one measurement object to the same reporting configuration, as well as to link more than one reporting configuration to the same measurement object. The measurement identity is used as a reference number in the measurement report.

4. Quantity configurations: One quantity configuration is configured per RAT type. The quantity configuration defines the measurement quantities and associated filtering used for all event evaluation and related reporting of that measurement type. One filter can be configured per measurement quantity.

5. Measurement gaps: Periods that the UE may use to perform measurements, i.e. no (UL, DL) transmissions are scheduled.

FIG. 9 is a diagram showing a method for a Long-DRX operation in the LTE system.

When the eNB wants the UE to be configured as the Long-DRX operation, the eNB sends RRC connection reconfiguration message to UE by enabling the power preference indicator (S901). This allows UE to be able to perform power preference indication procedure.

The UE decides to enter low power consumption mode. It sends the sends UE Assistance Information message to eNB with power preference indicator set to low power consumption (S903). The decision for UE initiating low power consumption mode may be based on the UE configuration by the network or UE implementation.

The eNB on receiving the UE assistance information provides UE with long DRX cycle in RRC Connection reconfiguration (S905). In RRC connection reconfiguration message there is ‘MAC config IE’ which includes the ‘DRX config IE’ which can be adjusted. Currently maximum value defined for DRX cycle length is 2.56 second. The eNB may assign maximum or higher DRX cycle to UE. Higher value of DRX cycle beyond 2.56 may be defined. Higher value of DRX cycle beyond 2.56 second requires analysis by 3GPP RAN WGs.

In the MAC layer, the DRX mechanism is used for power saving for the UE in RRC_CONNECTED. If DRX functionality is configured for the UE, the UE is allowed to monitor the PDCCH discontinuously, i.e., in the Active Time. The Active Time is determined by events and DRX-related timers such as pending SR, pending HARQ, or onDurationTimer. Thus, the UE would stay in the duration of inactivity when there is no data communication with the network.

If the UE is experiencing a poor quality of service, the network decides to handover the UE. For this purpose, the UE may assist the network by sending measurement report. If the network decides to handover the UE, the UE may receive the RRC signal from the network, i.e., RRCConnectionReconfiguration including the mobilityControlInfo.

If the UE is configured with DRX functionality, the UE should be in Active Time and monitors the PDCCH to receive the RRC signal from the network. However, there could be a case that the network decides to handover the UE, but the UE is in the duration of inactivity. In this case, the UE and the network should wait for a long time until the UE is in Active Time.

If the UE is using a very long DRX cycle, e.g., tens of seconds or several minutes, there could be a case that the UE and the network wait for a very long time and the handover fails. Conventionally, there is no way that UE transits to the Active Time in order to receive the RRC signal for handover from the network in the case that the radio quality is poor.

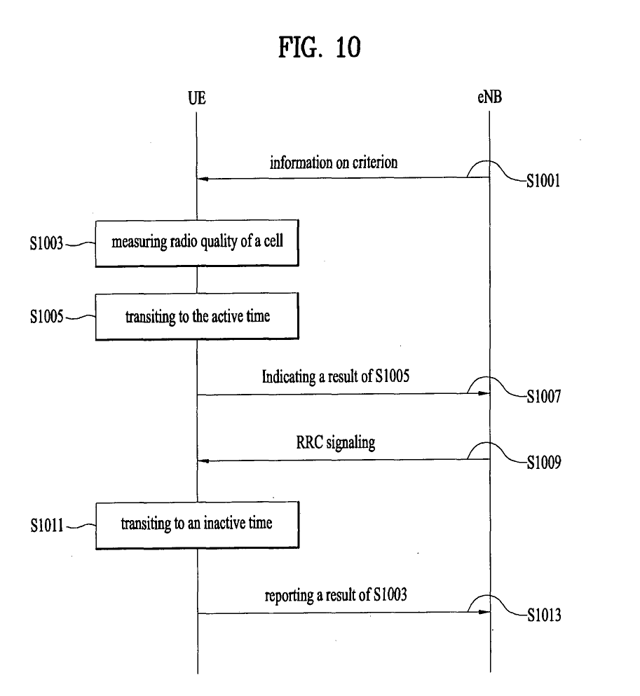

FIG. 10 is a conceptual diagram for performing a DRX operation according to embodiments of the present invention.

In this invention, it is proposed that the UE, configured with the DRX operation, may transit to an Active Time according to the radio quality and the interference level of the serving cell and the neighboring cells. In detail, if the radio quality and the interference level is fulfilled a certain condition, the UE may transit to the Active Time in order to receive an RRC signal from the network for the handover.

Regarding FIG. 10, the UE may receive information on criterion for transition to the Active Time (S1001). And the UE may measure radio quality of a cell (S1003). The UE may measure the radio quality in terms of the received signal power and the received signal quality. The radio quality may comprise radio quality of a serving cell and interference level of neighboring cells, etc.

The UE may obtain the measurement result of the radio quality from the Reference Signal Received Power (RSRP), and obtain the measurement result of the interference level from the Reference Signal Received Quality (RSRQ).

Based on result of measurement of the step of S 1003, the UE may compare between the result of measurement and the information on criterion. When the radio quality meets the criterion, the UE may transit to the Active Time (S1005).

The UE may consider that the radio quality measuring in the step of S1003 met the criterion in the following cases.
Measured radio quality of the serving cell is worse than a threshold.
Measured radio quality of the neighboring cell is better than a threshold.
Measured radio quality of the serving cell is offset better than measured radio quality of the neighboring cell.
Measured radio quality of the serving cell is worse than a threshold1 and measured radio quality of the neighboring cell is better than a threshold2.
Interference level of the serving cell is worse than a threshold.
Interference level of the neighboring cell is better than a threshold.
Interference level of the serving cell is offset worse than interference level of the neighboring cell.
Interference level of the serving cell is worse than a threshold1 and interference level of the neighboring cell is better than a threshold2.
Any combination of above cases,
   e.g., measured radio quality of the serving cell is worse than a threshold1, and the interference level of the neighboring cell is better than a threshold2.
   e.g., measured radio quality of the neighboring cell is better than a threshold1, and the interference level of the serving cell is better than a threshold 2.
Additionally, Event A2, A3, A4, or A5 occurs.

*Event A2: The Serving Cell Becomes Worse than a Threshold.

UE may consider the entering condition for this event to be satisfied when condition “Ms+Hys<Thresh” is fulfilled. And UE may consider the leaving condition for this event to be satisfied when condition “Ms+Hys>Thresh” is fulfilled.

Here, ‘Ms’ is the measurement result of the serving cell, not taking into account any offsets and is expressed in dBm in case of RSRP or in dB in case of RSRQ, ‘Hys’ is the hysteresis parameter for this event and is expressed in dB, and ‘Thresh’ is the threshold parameter for this event and is expressed in the same unit as Ms.

*Event A3: Neighboring Becomes Offset Better than PCell.

UE may consider the entering condition for this event to be satisfied when condition “Mn+Ofn+Ocn−Hys>Mp+Ofp+Ocp+Off” is fulfilled. And UE may consider the leaving condition for this event to be satisfied when condition “Mn+Ofn+Ocn−Hys<Mp+Ofp+Ocp+Off” is fulfilled.

Here, ‘Mn’ is the measurement result of the neighboringing cell, not taking into account any offsets, ‘Mp’ is the measurement result of the PCell, not taking into account any offsets and ‘Mn and Mp’ are expressed in dBm in case of RSRP, or in dB in case of RSRQ.

And ‘Ofn’ is the frequency specific offset of the frequency of the neighboring cell, ‘Ocn’ is the cell specific offset of the neighboring cell, and set to zero if not configured for the neighboring cell, ‘Ofp’ is the frequency specific offset of the primary frequency, ‘Ocp’ is the cell specific offset of the PCell and is set to zero if not configured for the PCell, ‘Hys’ is the hysteresis parameter for this event, ‘Off’ is the offset parameter for this event and ‘Ofn, Ocn, Ofp, Ocp, Hys and Off’ are expressed in dB.

*Event A4: Neighboring Becomes Better than Threshold.

UE may consider the entering condition for this event to be satisfied when condition “Mn+Ofn+Ocn−Hys>Thresh” is fulfilled. And UE may consider the leaving condition for this event to be satisfied when condition “Mn+Ofn+Ocn−Hys<Thresh” is fulfilled.

*Event A5: PCell Becomes Worse than Threshold1 and Neighboring Becomes Better than Threshold2.

UE may consider the entering condition for this event to be satisfied when both condition “Mp+Hys<Thresh1” and condition “Mn+Ofn+Ocn-Hys>Thresh 2” are fulfilled. And UE may consider the leaving condition for this event to be satisfied when condition “Mp-Hys<Thresh1” or condition “Mn+Ofn+Ocn+Hys<Thresh 2”, i.e. at least one of the two is fulfilled.

In the cases listed above, the UE may transit to the Active Time and keeps staying in the Active Time to receive an RRC signal from a base station in the cell.

And the UE may indicate a result of the step of S1005, to the base station in the cell (S1007).

To receive an RRC signal for handover, the UE may stay in the Active Time for certain duration of time/subframes or until when the UE receive an RRC signal from the base station in the cell. When the RRC signaling is received from the cell during the Active Time (S1009), the UE may transit to an Inactive Time immediately (S1011).

Desirably, the RRC signal may be a handover command signaling, i.e., RRCConnectionReconfiguration including MobilityControlInfo.

Additionally, the UE may also transmit a result of the step of S1003, to the base station in the cell (S1013).

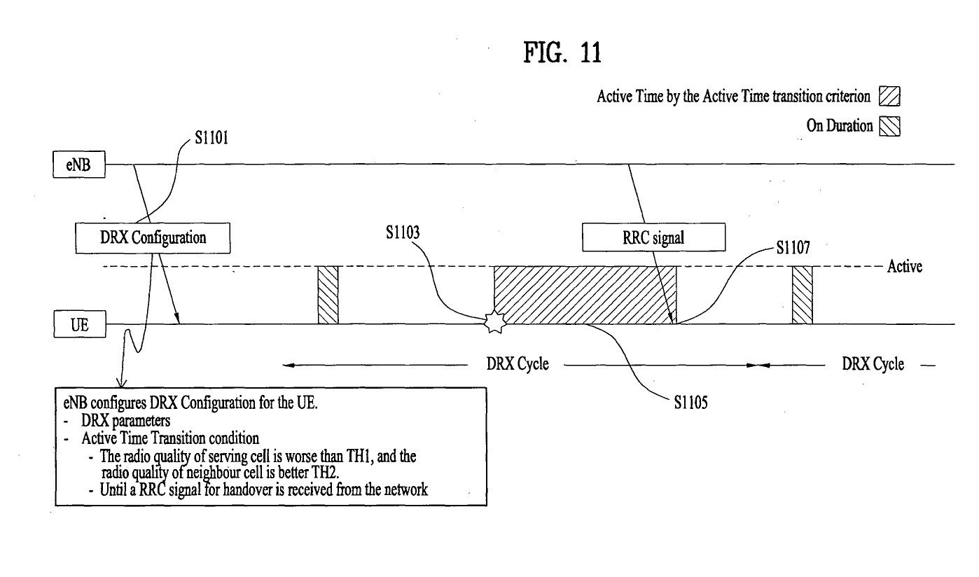

FIG. 11 is conceptual diagram an exemplary an Active Time according to embodiments of the present invention.

The UE may receive DRX configuration information (S1101). The DRX configuration information may include DRX parameter and Active Time transition condition.

For example, the Active Time transition condition may configure the UE to transit to the Active Time when the radio quality of the serving cell is worse than the threshold 1, TH1, and the radio quality of the neighboring cell is better than the threshold 2, TH2, in the meantime.

When the radio quality of the serving cell becomes worse than TH1, and in the meantime, the radio quality of the neighboring cell becomes better than TH2, the UE may decide to transit to the Active Time (S1103). And the UE may stay the Active Time until when the UE receives the RRC signal for handover from the network (S1105).

When the UE receives the RRC signal for handover from the network, the UE may operate with the DRX functionality according to the DRX related timers (e.g., drx-InactivityTimer) and DRX related events (e.g., SR pending, HARQ pending) and transit an Inactive Time immediately (S1107).

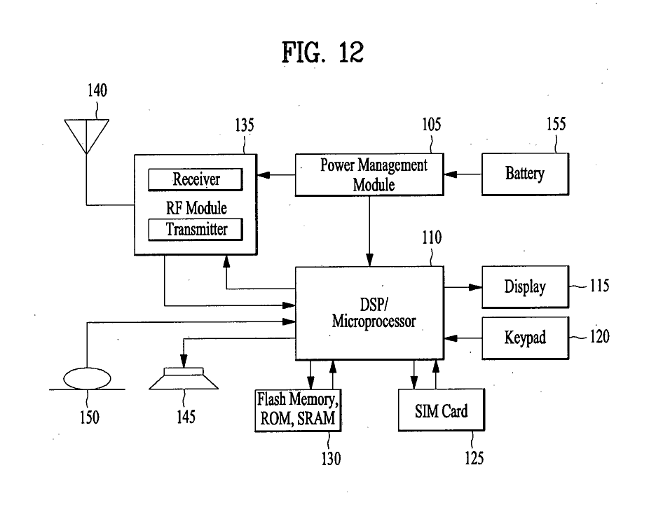

FIG. 12 is a block diagram of a communication apparatus according to an embodiment of the present invention.

The apparatus shown in FIG. 12 can be a user equipment (UE) and/or eNB adapted to perform the above mechanism, but it can be any apparatus for performing the same operation.

As shown in FIG. 12, the apparatus may comprises a DSP/microprocessor (110) and RF module (transmiceiver; 135). The DSP/microprocessor (110) is electrically connected with the transciver (135) and controls it. The apparatus may further include power management module (105), battery (155), display (115), keypad (120), SIM card (125), memory device (130), speaker (145) and input device (150), based on its implementation and designer's choice.

Specifically, FIG. 12 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 12 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

While the above-described method has been described centering on an example applied to the 3GPP LTE system, the present invention is applicable to a variety of wireless communication systems in addition to the 3GPP LTE system.

1. A method for a user equipment (UE) configured with a DRX (Discontinuous Reception) operation in a wireless communication system, the method comprising:
receiving information on criterion for transition to an Active Time;
measuring radio quality of a cell; and
transiting to the Active Time when the radio quality meets the criterion.

2. The method according to claim 1, further comprising:
receiving an RRC (Radio Resource Control) signaling is received from a base station (BS) in a serving cell during the Active Time.

3. The method according to claim 2, further comprising:
transiting to an Inactive Time when the RRC signaling is received from the BS during the Active Time.

4. The method according to claim 2, wherein the RRC signaling is a handover command signaling.

5. The method according to claim 1, further comprising:
indicating a result of said transiting to the Active Time, to a base station in a serving cell.

6. The method according to claim 1, further comprising:
transmitting a result of said measuring the radio quality of the cell, to a base station in a serving cell.

7. A user equipment (UE) in a wireless communication system, the UE comprising:
an RF module; and
a processor configured to control the RF module,
wherein the processor is configured to receive information on criterion for transition to an Active Time, measure radio quality of a cell; and transit to the Active Time when the radio quality meets the criterion.

8. The UE according to claim 7, wherein the processor is further configured to receive an RRC (Radio Resource Control) signaling is received from a base station (BS) in a serving cell during the Active Time.

9. The UE according to claim 8, wherein the processor is further configured to transit to an Inactive Time when the RRC signaling is received from the BS during the Active Time.

10. The UE according to claim 8, wherein the RRC signaling is a handover command signaling.

11. The UE according to claim 7, wherein the processor is further configured to indicate a result of said transiting to the Active Time, to a base station in a serving cell.

12. The UE according to claim 7, wherein the processor is further configured to transmit a result of said measuring the radio quality of the cell, to a base station in a serving cell.
